(19) United States
(12) Patent Application Publication
(10) Pub. No.: US 2019/0154530 A1
(43) Pub. Date: May 23, 2019

(54) METHOD AND DEVICE FOR DETECTING A COLLISION OF A VEHICLE

(71) Applicant: Robert Bosch GmbH, Stuttgart (DE)

(72) Inventor: Gunther Lang, Stuttgart (DE)

(21) Appl. No.: 16/174,449

(22) Filed: Oct. 30, 2018

(30) Foreign Application Priority Data
Nov. 23, 2017 (DE) 102017220910.0

(51) Int. Cl. G01L 5/00; G07C 5/08

(52) U.S. Cl. CPC G01L 5/0052; G07C 5/08

(57) ABSTRACT

A method for detecting a collision of a vehicle. In this context, at least one threshold value for determining at least one collision type of the collision, is modified, using an environmental information item, which represents an information item that is supplied by at least one surround sensor of the vehicle and is in regard to the collision, in order to obtain at least one modified threshold value. In a further step, the collision type is determined, using the modified threshold value and a non-environmental information item, which represents an information item that is in regard to the collision and is supplied by at least one acceleration and/or pressure sensor of the vehicle, in order to detect the collision.

### CROSS REFERENCE

The present application claims the benefit under 35 U.S.C. § 119 of German Patent Application No. DE 102017220910.0 filed on Nov. 23, 2017, which is expressly incorporated herein by reference in its entirety.

### FIELD

The present invention is directed to a method and a device for detecting a collision of a vehicle. The present invention also includes a computer program.

### BACKGROUND INFORMATION

An air bag control unit seated on the vehicle tunnel is typically used to detect vehicle collisions. The algorithm used for detecting head-on collisions is based primarily on acceleration signals in the longitudinal direction (x-direction). Generally, the acceleration sensor is seated in the central airbag control unit on the vehicle tunnel, but may also be installed externally. In addition to this central x-sensor, further sensors are used, such as a central acceleration sensor measuring in the longitudinal direction (y-direction) or externally mounted acceleration sensors. If these are installed in the front end of the vehicle, then they are so-called up-front sensors, which sense in the x-, and in some instances, also the y-direction. If these are installed at the lateral vehicle periphery, for example, on the B-pillar, then these so-called PAS's (PAS=peripheral acceleration sensor) sense in the y-, and in some instances, also in the x-direction. Pressure sensors may also be used for detecting collisions.

In order to correctly trigger the restraining devices in many different collision scenarios, the activation algorithms should identify both the collision type, such as complete overlap, offset, angle or pole, as well as the correct collision severity based on it. In this case, collision severity means a discrete output variable CS, which may assume, for example, the values CS=0 for no activation of restraining devices, CS=1 for activation of belt tensioners, CS=2 for the activation of airbag stage 1, or CS=3 for the activation of airbag stage 2.

Generally, a purely collision-severity-based algorithm approach, in which, for example, processed characteristics of the central x-sensor are compared to activation thresholds, yield a satisfactory performance in the case of a collision having complete overlap, since in this case, the entire crumple zone of the vehicle, in particular, the two crash boxes, are deformed, and high acceleration values occur. However, in collisions at an angle or having marked offset, that is, with less than the full overlap, the crumple zone of the vehicle is only partially deformed. Due to this, only low acceleration signals, which hinder or do not allow timely detection of the collision, occur in the collision phase relevant to activation, which means that in collisions at an angle or having an offset, restraining devices are often activated too late in algorithms purely based on collision severity.

For this reason, activation algorithms also use functions for identifying the collision type, for example, the angle or the offset. If, for example, a collision has been identified as an offset collision, then the sensitivity of the activation thresholds based on collision severity may be adapted, that is, as a rule, made more sensitive, in order to allow timely activation of restraining devices in spite of the low acceleration signal in the offset collision. This means that the identification of collision type influences the subsequent detection of collision severity. In addition, specific restraining devices may also be activated exclusively in a particular type of collision, for instance, the triggering of head airbags facing the collision in angle or offset collisions.

Collision-type identification units for identifying angle collisions typically evaluate the lateral acceleration components of the collision, which are acquired by the acceleration sensors measuring in the y-direction. Collision-type identification units for detecting the offset are typically based on a comparison of acceleration signals measured on the left and right vehicle peripheries, for example, by comparison of up-front sensor signals or PAS signals.

In recent times, the rate of equipping vehicles with predictive sensors, such as radar or video systems, for the purpose of assisting the driver, has increased steadily. Even prior to a possible collision, these sensors supply information, which is relevant to a collision and may be considered for the correct control of restraining devices in the airbag algorithm. In this context, the focus is initially on information relevant to collision intensity, that is, in particular, on the relative speed of the ego vehicle and the opposing object. This information may be used directly or indirectly for influencing the activation thresholds based on collision intensity.

Apart from the relative speed, predictive sensors may also supply information regarding the expected collision type, for instance, regarding the angle or degree of overlap. One simple option for using this information to adapt threshold values to lateral accelerations is described in U.S. Pat. No. 9,415,737 B2.

### SUMMARY

In accordance with the present invention, a method and device for detecting a collision of a vehicle are provided, as well as a corresponding computer program. Advantageous further refinements and improvements of the example device are rendered possible by the measures described herein.

In accordance with the present invention, information, which is supplied by a predictive sensor system and is in regard to, for instance, an expected collision type, may be merged with collision-type identification functions, which are based on acceleration or pressure and are already present in the airbag control unit, in order to allow the most effective identification possible of the collision type. An object of the present invention is, inter alia, to directly associate, in each instance, a specific collision-type information item of the predictive sensor system with the corresponding classical, collision-type identification function, that is, one based on acceleration or pressure sensor systems. The combination of the two corresponding information items may advantageously be carried out flexibly and therefore allows highly precise and highly robust collision-type identification, in particular, in the gray area between different collision types. This is achieved in that a final classification is made by the classical collision-type identification functions, whose sensitivity is controlled, in this context, by the information of the predictive sensor system. Such a merger of collision-type information of a predictive sensor system with that of a classical acceleration or pressure sensor system results in improved activation of restraining devices in the collision.

The present invention includes, inter alia, options for how an expected collision type supplied by a predictive sensor system may be combined with the functions, which are for determining the collision type in the collision and are based on acceleration or pressure information items, in order to obtain an optimal, merged information item regarding the collision type.

A method for detecting a collision of a vehicle is put forward, the method including the following steps:

modifying at least one threshold value for determining at least one type of collision, using an environmental information item, which represents an information item that is in regard to the collision and is supplied by at least one surround sensor of the vehicle, in order to obtain at least one modified threshold value; and

determining the collision type, using the modified

threshold value and a non-environmental information item, which represents information that is in regard to the collision and is supplied by at least one acceleration and/or pressure sensor of the vehicle, in order to detect the collision. This method may be implemented, for example, as software or hardware, or in a combined form of software and hardware, in, for example, a control unit.

A threshold value may be understood as, for example, an individual value, a combination of a plurality of values, or a threshold value curve. A collision type may be understood as a particular category for classifying collisions. For example, the collision type may be a head-on collision with an offset obstacle, a head-on collision over the full width of the vehicle, a lateral collision, a pole collision, an angle collision, or another category for distinguishing collisions. For example, a surround sensor may be understood as a radar, lidar or ultrasonic sensor, or a camera. The environmental information item may be, for example, a degree of overlap, a collision angle, a width of a collision object, an impact position or a combination of a plurality of such variables. A non-environmental information item may be understood, for example, as an acceleration or a pressure or another physical variable not measured by an impact sensor, or a combination of a plurality of such variables.

According to one specific embodiment, in the modifying step, the threshold value may be modified, using an environmental information item, which represents a degree of overlap and/or a collision angle and/or a width of a collision object and/or an impact position. A degree of overlap may be understood as a degree of overlap of the vehicle and the collision object. A collision angle may be understood as an angle, at which the vehicle and the collision object collide with each other. An impact position may be understood as a location, at which the collision object strikes the vehicle. This allows precise and robust detection of the collision.

According to a further specific embodiment, in the modifying step, an overlap threshold value may be modified, using the degree of overlap, in order to obtain a modified overlap threshold value. Additionally or alternatively, an angle threshold value may be modified, using the collision angle, in order to obtain a modified angle threshold value. Additionally or alternatively, a pole threshold value may be modified, using the object width and the impact position, in order to obtain a modified pole threshold value. In this context, depending on the specific embodiment, in the determining step, a laterally offset, head-on collision may be determined as the collision type, using the modified overlap threshold value, an angle collision may be determined as the collision type, using the modified angle threshold value, or a pole collision may be determined as the collision type, using the modified pole threshold value. A laterally offset, head-on collision, also known as an offset crash, may be understood as a collision having partial overlap. A pole collision may be understood as a collision, in which the vehicle collides with a pole-shaped object. Using this specific embodiment, it may be ensured that the environmental information item is reliably associated with different collision types.

The method may include a step of predetermining at least one expected collision type, using the environmental information item. In this context, in the modifying step, the threshold value may be modified, using the expected collision type. An expected collision type may be understood as, for example, a collision type, which was determined prior to the collision type determined in the determining step. In this manner, the efficiency of the method may be improved.

In the predetermining step, it is advantageous for an expected, laterally offset, head-on collision, an expected angle collision, an expected pole collision, or a combination of at least two of the above-mentioned collisions, to be predetermined as the expected collision type. In this manner, the expected collision type may be determined in a manner analogous to the collision type. This reduces the computing expenditure during the detection of the collision.

In addition, the method may include a step of ascertaining a severity of the collision, using the collision type and the non-environmental information item. In particular, this allows the environmental information item regarding the collision type to not influence the collision-intensity thresholds, but to be integrated earlier in the processing chain in a deliberate manner, namely, already in the collision-type thresholds. The collision intensity may also be ascertained particularly reliably and robustly in this manner.

The approach put forward here further provides a device, which is configured to perform, control and/or implement the steps of a variant of a method put forward here, in corresponding devices. The object of the present invention may also be achieved rapidly and efficiently by this embodiment variant of the present invention, in the form of a device.

To this end, the device may include at least one arithmetic unit for processing signals or data, at least one storage unit for storing signals or data, at least one interface to a sensor or to an actuator for inputting sensor signals from the sensor or for outputting data signals or control signals to the actuator, and/or at least one communications interface for inputting or outputting data, which are embedded in a communications protocol. The arithmetic unit may be, for example, a signal processor, a microcontroller or the like; the storage unit being able to be a flash memory, an EPROM or a magnetic storage unit. The communications interface may be configured to input or output data wirelessly and/or in a line-conducted manner; a communications interface, which can input or output line-conducted data, being able to input or output these data, for example, electrically or optically, from a corresponding data transmission line or to a corresponding data transmission line, respectively.

In the case at hand, a device may be understood as an electrical device that processes sensor signals and outputs control and/or data signals as a function of them. The device may have an interface, which may be implemented as hardware and/or software. In a hardware design, the interfaces may, for example, be part of a so-called system ASIC that includes many different functions of the device. However, it is also possible for the interfaces to be separate, integrated circuits or to be at least partially made up of discrete components. In a software design, the interfaces may be software modules that are present, for example, on a microcontroller in addition to other software modules.

Also advantageous is a computer program product or computer program, including program code, which may be stored on a machine-readable carrier or storage medium, such as a solid state memory, a hard disk storage device or an optical storage device, and is used for performing, implementing and/or controlling the steps of the method according to one of the above-described specific embodiments, in particular, when the program product or program is executed on a computer or a device.

Exemplary embodiments of the present invention are shown in the figures and are explained in greater detail below.

### BRIEF DESCRIPTION OF THE DRAWINGS

FIG. 1 shows a schematic representation of a path algorithm for identifying a collision severity.

FIG. 2 shows a schematic representation of an algorithm including sensitivity control based on collision type.

FIG. 3 shows a graph for representing a collision-type identification function.

FIG. 4 shows a graph for representing a collision-type identification function.

FIG. 5 shows a graph for representing a collision-type identification function.

FIG. 6 shows a schematic representation of a vehicle including a device according to an exemplary embodiment.

FIG. 7 shows a schematic representation of an architecture of an algorithm for use with a device according to an exemplary embodiment.

FIG. 8 shows a schematic representation of an architecture of an algorithm for use with a device according to an exemplary embodiment.

FIG. 9 shows a flow chart of a method according to an exemplary embodiment.

### DETAILED DESCRIPTION OF EXAMPLE EMBODIMENTS

In the description below of preferred exemplary embodiments of the present invention, the same or similar reference numerals are used for the elements that are depicted in the different figures and function similarly, in which case a repeated description of these elements is omitted.

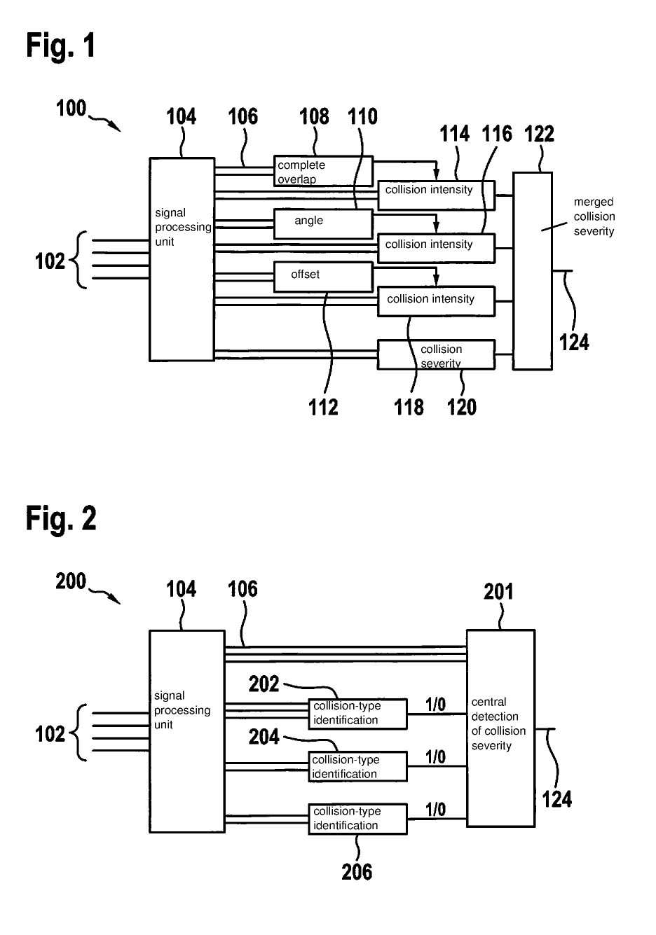

FIG. 1 shows a schematic representation of a path algorithm 100 for detecting a collision severity. As already described, existing airbag algorithms may include functions, which are for identifying the collision type, and by which the sensitivity of the evaluation of the collision severity is controlled. In principle, this may be accomplished in two ways. FIG. 1 schematically shows a so-called path algorithm. After suitable preprocessing of acceleration and pressure signals 102 by a signal processing unit 104 to form so-called signal characteristics 106, for example, by filtering or integration, then, based on a specific subset of signal characteristics, a collision-type identification is made for different types of collisions, for example, “complete overlap” in a block 108, “angle” in a block 110, or “offset” in a block 112. The collision-type identifications are often designed in such a manner, that exclusively one collision type may only be present, but this is not necessary.

If the criteria for a collision type are satisfied, then, based on a further subset of signal characteristics (which may agree with the signal characteristics used for the collision-type identification or deviate from them), an identification of the collision severity is subsequently made for the specific collision type in three blocks 114, 116, 118. In addition to the collision severity queries exclusive to the collision type, as a rule, a default path, which performs a collision severity determination independently of the ascertained collision type and therefore ensures a basic performance, also exists in such path algorithms. This is carried out in a block 120. In each collision severity path, a different subset of signal characteristics may generally be used. Subsequently, in a block 122, the collision severities detected by the different paths are merged to form a merged collision severity 124, for example, by simply calculating the maximum. This is then used for controlling the restraining devices.

FIG. 2 shows a schematic representation of an algorithm 200 including sensitivity control based on the type of collision. In contrast to FIG. 1, FIG. 2 shows an algorithm including, in a block 201, central detection of collision severity that functions on the basis of a subset of signal characteristics. In addition to that, there are different collision-type identification units in blocks 202, 204, 206, which work, in turn, with a suitable set of signal characteristics 106 and supply a yes/no or 1/0 decision for the respective collision type. This input is now used in the central collision-severity detection unit, in order to influence the sensitivity of the threshold values used.

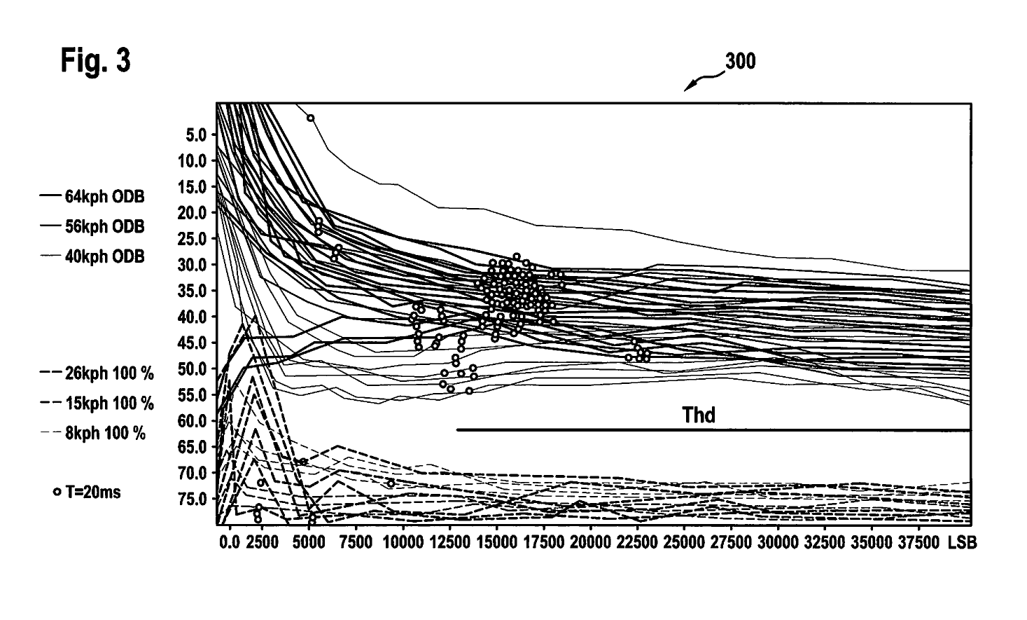

The collision-type identification units themselves use the signal characteristics suitable for identifying the specific collision type. For example, the “angle” collision type may be identified, using threshold value queries for a processed y-signal, the “offset” collision type may be identified, using threshold value queries for a signal characteristic, which is based on a processed difference of acceleration sensors on the left and right sides of the vehicle, for example, a left or right up-front sensor sensing in the longitudinal direction, or a left or right PAS sensing in the longitudinal direction. Typically, a large proportion of collisions is already classified correctly by these collision-type identification functions. An incorrect classification may only occur in a few attempts and/or under consideration of higher tolerances. This may result in non-optimum control of the restraining devices, since then, the collision-intensity queries are not optimized for the type of collision at hand. This is illustrated, by way of example, for a collision-type identification function for offset collisions, as shown in FIG. 3.

FIG. 3 shows a graph 300 for representing a collision-type identification function for the “offset” characteristic. The offset signal characteristic is plotted versus a collision progress characteristic, for example, an algo-timer. As of a certain degree of progress of the collision, the offset collision type is identified as a function of a comparison of the offset signal characteristic and a threshold value Thd. If the offset signal characteristic is below the threshold value and the threshold value query is consequently not satisfied, then the offset collision type is not present: offset=0. Offset=1 above threshold value Thd. This distinction already functions reliably for plotted collision data ODB and slow, flat, head-on collisions. However, by viewing further system tolerances or crash tests having slightly different parameters, for example, 60% overlap in place of 40%, as in the case of ODB, a gray area may be produced, in which the desired collision type is possibly not identified correctly.

Using a predictive surround sensor system, such as radar, lidar, video or a combination of them, then, in addition to the relative speed, information about the expected collision type may also be extracted. Such variables include, for example, impact angle, degree of overlap, object width or impact position.

Expected collision types may be derived from these variables, using suitable threshold value queries and combinations of a plurality of threshold value queries. For example, the expected collision type is an angle collision, if the impact angle is greater than 20°, or an offset collision, if the degree of overlap is less than 60% or the impact position is more than 50 cm outside of the center axis of the vehicle. These expected collision types may be, but do not have to be, mutually exclusive.

Ideally, the same categories are present for this expected collision type as for the collision types in the classical airbag algorithm.

Now, for example, a combination of expected collision type and actual collision type detected via the acceleration sensor system is a Boolean combination, such as: final collision type=offset, if collision type=offset and expected collision type=offset.

However, a disadvantage of such a Boolean combination is that a highly reliable collision-type identification via the acceleration sensor system may be made void by an incorrect, expected collision type.

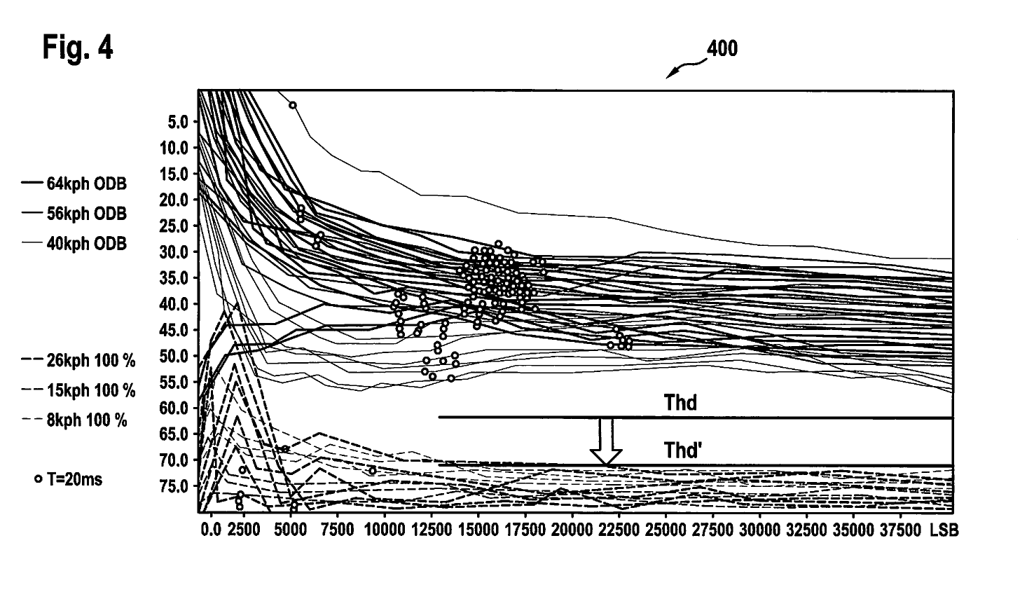

Therefore, it is more advantageous to use an expected collision type as an input in the corresponding classical collision-type function, in order to thereby control the threshold sensitivity. If, for example, the expected collision type =offset, then a more sensitive threshold may be used in the acceleration-based offset identification, in order to allow reliable identification of offset collisions. FIG. 4 shows the influencing of the “offset” collision-type identification function, if the expected collision type=offset.

FIG. 4 shows a graph 400 for representing a collision-type identification function. Shown, are threshold value Thd, as in FIG. 3, as well as a modified threshold value Thd′. In a way, the predictive sensor system assumes, here, a change of course in the direction of an offset collision. However, if the collision does not show any characteristics at all of an offset collision in the acceleration signals (offset characteristic very close to zero), then this collision continues not to be identified as an offset collision. In this case, an incorrect classification by the predictive sensor system is intercepted.

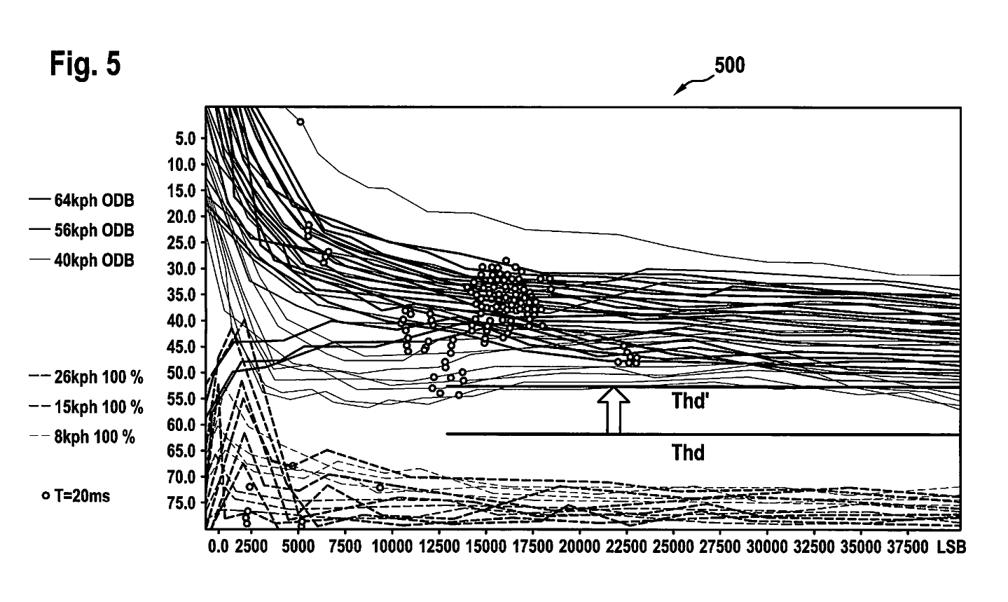

If the expected collision type =no offset, then a more robust threshold may be used in the acceleration-based offset identification unit, in order to hinder the detection of offset collisions and to make the identification of non-offset collisions more robust, as is shown in FIG. 5.

FIG. 5 shows a graph 500 for representing a collision-type identification function. The influencing of the “offset” collision-type identification function, if the expected collision type=no offset, is shown. In a way, the predictive sensor system assumes a change of course in the direction of “no offset collision.” However, if the collision shows very clear characteristics of an offset collision in the acceleration signals (very high offset characteristic), this collision continues to be identified as an offset collision. In this case, an incorrect classification by the predictive sensor system is intercepted.

A two-dimensional threshold value curve may also be used in place of a constant threshold value. In place of switching to an different threshold value or a different threshold value curve on the basis of the expected collision type, an existing threshold value or an existing threshold value curve may also be reduced or increased by a constant or relative amount in a resource-conserving manner.

In an analogous manner, the presence or absence of the expected “angle” collision type influences the sensitivity of a classical “angle” collision-type identification function, etc.

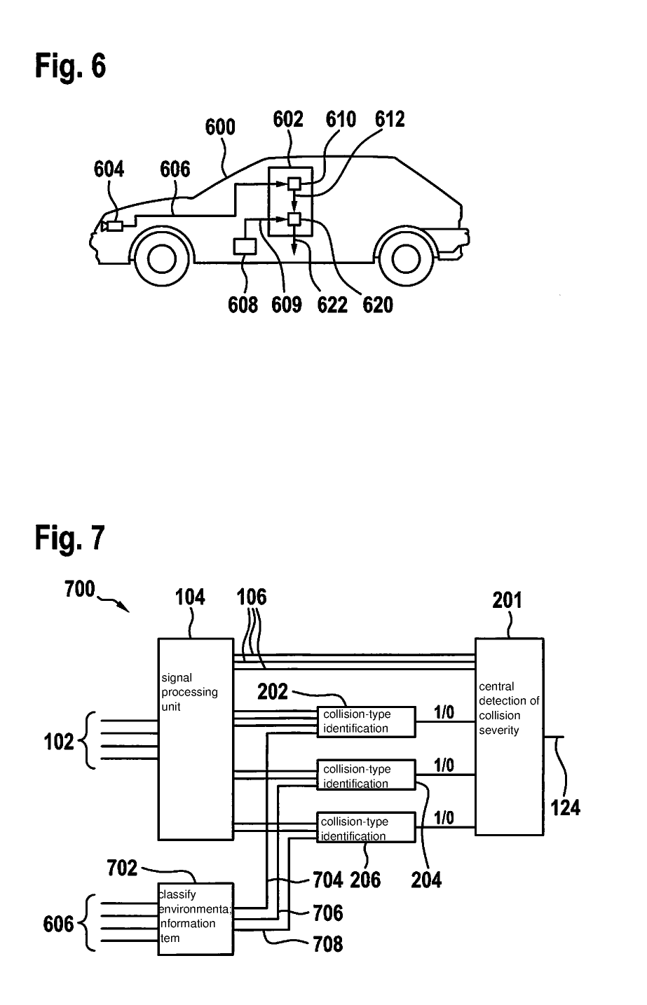

FIG. 6 shows a schematic representation of a vehicle 600 including a device 602 according to one exemplary embodiment. Vehicle 600 is equipped with a surround sensor 604 for supplying an environmental information item 606 representing a collision of vehicle 600, and with a further sensor 608 for supplying a non-environmental information item 609 representing an acceleration or also a pressure. Non-environmental information item 609 may represent, for example, the acceleration and pressure signals, as are described above as signal characteristics 106, in light of FIGS. 1 and 2. Sensor 608 is integrated, for example, in a control unit on the vehicle tunnel of vehicle 600. Device 602 includes a modification unit 610, which is configured to modify, using environmental information item 606, at least one threshold value for determining at least one collision type of the collision. Modification unit 610 outputs a modified threshold value 612 as a result of this modification. A determination unit 620 of device 602 is configured to determine the collision type, using modified threshold value 612 and non-environmental information item 609. As a result of the determination, determination unit 620 outputs a collision-type information item 622 representing the collision type. It is also possible for a collision-type information item 622 to be undertaken up to the determination of the collision severity. In this connection, for example, a selection of the “correct” collision-intensity blocks 114 to 118 in FIG. 1 may be made. For example, a determination of the threshold value may also be carried out in a central crash-severity detection unit in block 201 from FIG. 2.

FIG. 7 shows a schematic representation of an architecture of an algorithm 700 for use with a device according to an exemplary embodiment, for instance, the device described above in light of FIG. 6. What is shown is a possible architecture for an algorithm including sensitivity control based on collision type, that is, in view of an expected collision type derived from a predictive sensor system. The architecture basically corresponds to the architecture represented in FIG. 2, except that according to the exemplary embodiment shown in FIG. 7, input data in the form of environmental information item 606, which represent, for example, a degree of overlap, an angle, an object width or an impact position, are classified in a block 702, and from them, by way of example, three corresponding, expected collision types 704, 706, 708 for offset, angle and pole collisions are derived. These expected collision types are now used as input data for, in each instance, corresponding classical collision-type identification functions represented by the three blocks 202, 204, 206, within which they are able to influence the threshold values for identifying the collision type. The respective output data of the three blocks 202, 204, 206 go into block 201 for detecting collision severity.

The architecture of a path algorithm 100 (FIG. 1) may be modified in a completely analogous manner; the expected collision types derived from the surround sensor system being further inputs for the classical collision-type identification functions 108, 110, 112, within which they may influence the threshold values for the collision-type identification.

According to one exemplary embodiment, in the case of mutually exclusive, expected collision types, in place of different Boolean variables for the individual, expected collision types, such as the expected offset collision type or expected angle collision type, a common “expected collision type” variable is also used, which may then assume a plurality of states, such as an offset, angle or pole collision.

The classification of environmental information item 606 under expected collision types takes place, for example, in an airbag control unit on the basis of the input data received. As an alternative, this already takes place in a control unit of the predictive sensor system, also referred to above as a surround sensor. Then, the control unit already transmits the expected collision type to the airbag control unit.

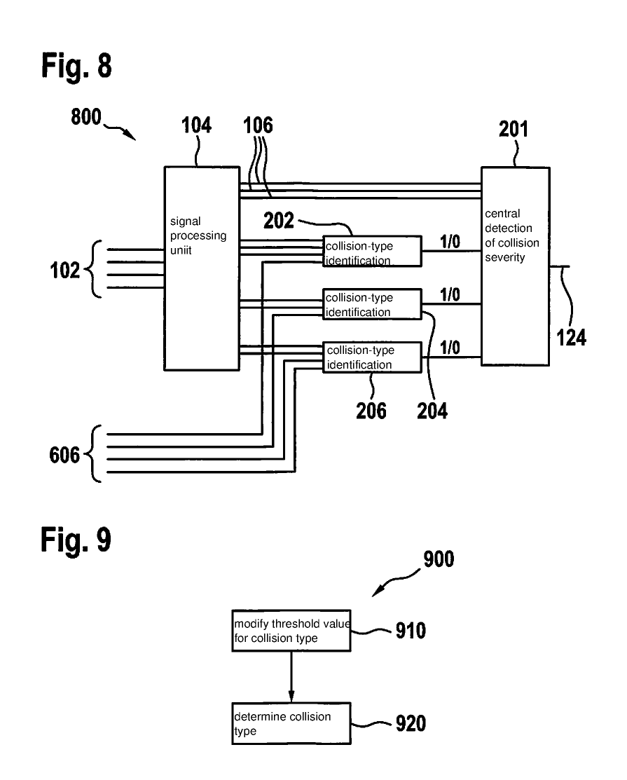

In place of classifying the input variables of the predictive sensor system under expected collision types, it is also possible to process the input variables directly in the classical collision-type identification functions, as is depicted in FIG. 8.

FIG. 8 shows a schematic representation of an architecture of an algorithm 800 for use with a device according to an exemplary embodiment, for instance, the device described above in light of FIG. 6. In contrast to FIG. 7, the input variables of the predictive sensory system, which are represented by environmental information item 606, go directly into the collision-type identification functions of blocks 202, 204, 206. In this connection, suitable data of the predictive sensor system are inputted by a classical collision-type identification function. According to the exemplary embodiment shown in FIG. 8, the offset identification function in block 202 processes a “degree of overlap” input, the angle identification function in block 204 processes the “angle” input, and the pole identification function in block 206 processes, in each instance, an input for “object width” and “impact position.” An advantage of this is that the threshold values in the collision-type identification functions may be varied continuously as a function of the input variable of the predictive sensor system. For example, the offset threshold value is varied continuously as a function of the degree of overlap: Thd_Offset=f(degree of overlap). This allows more precise control than the yes/no input of an expected collision type.

FIG. 9 shows a flow chart of a method 900 according to an exemplary embodiment. Method 900 for detecting a collision of a vehicle may be executed, for example, by the device as described above in light of FIG. 6. In this context, in a first step 910, at least one threshold value for determining at least one collision type of the collision, using the environmental information item, is modified, in order to obtain at least one modified threshold value. In a second step 920, the collision type, with the aid of which the collision is identifiable, is determined, using the modified threshold value and the non-environmental information item, that is, a signal of an acceleration or pressure sensor of the vehicle.

If an exemplary embodiment includes an “and/or” conjunction between a first feature and a second feature, then this is to be read such that, according to one specific embodiment, the exemplary embodiment includes both the first feature and the second feature, and according to another specific embodiment, the exemplary embodiment includes either only the first feature or only the second feature.

What is claimed is:

1. A method for detecting a collision of a vehicle or a collision type, the method comprising:
modifying at least one threshold value for determining at least one collision type of the collision, using an environmental information item, which represents an information item that is supplied by at least one surround sensor of the vehicle and is in regard to the collision, in order to obtain at least one modified threshold value; and
determining the collision type, using the modified threshold value and a non-environmental information item, which represents an information item that is in regard to the collision and is supplied by at least one acceleration and/or pressure sensor of the vehicle or derived from the modified threshold value and the non-environmental information item, to detect the collision and/or the collision type.

2. The method as recited in claim 1, wherein in the modifying step, the threshold value is modified, using an environmental information item, which represents a degree of overlap and/or a collision angle and/or an object width of a collision object and/or an impact position.

3. The method as recited in claim 2, wherein in the modifying step, at least one of: (i) an overlap threshold value is modified, using the degree of overlap, in order to obtain a modified overlap threshold value, and/or (ii) an angle threshold value is modified, using the collision angle, in order to obtain a modified angle threshold value, (iii) a pole threshold value is modified, using the object width and the impact position, in order to obtain a modified poll threshold value; and wherein in the determining step, at least one of: (i) a laterally offset, head-on collision, and/or (ii) an angle collision, and/or (iii) a pole collision, being determined as the collision type, using the modified overlap threshold value and/or the modified angle threshold value and/or the modified pole threshold value, respectively.

4. The method as recited in claim 1, further comprising:
predetermining at least one expected collision type, using the environmental information item;
wherein in the modifying step, the threshold value is modified, using the expected collision type.

5. The method as recited in claim 4, wherein in the predetermining step, an expected, laterally offset, head-on collision and/or an expected angle collision and/or an expected pole collision is predetermined as the expected collision type.

6. The method as recited in claim 1, further comprising:
ascertaining a collision intensity of the collision, using the collision type and the non-environmental information item.

7. A device, including units, which are configured to detect a collision of a vehicle or a collision type, the units configured to:
modify at least one threshold value for determining at least one collision type of the collision, using an environmental information item, which represents an information item that is supplied by at least one surround sensor of the vehicle and is in regard to the collision, in order to obtain at least one modified threshold value; and
determine the collision type, using the modified threshold value and a non-environmental information item, which represents an information item that is in regard to the collision and is supplied by at least one acceleration and/or pressure sensor of the vehicle or derived from the modified threshold value and the non-environmental information item, to detect the collision and/or the collision type.

8. A machine-readable storage medium on which is stored a computer program for detecting a collision of a vehicle or a collision type, the computer program, when executed by a computer, causing the computer to perform:
modifying at least one threshold value for determining at least one collision type of the collision, using an environmental information item, which represents an information item that is supplied by at least one surround sensor of the vehicle and is in regard to the collision, in order to obtain at least one modified threshold value; and
determining the collision type, using the modified threshold value and a non-environmental information item, which represents an information item that is in regard to the collision and is supplied by at least one acceleration and/or pressure sensor of the vehicle or derived from the modified threshold value and the non-environmental information item, to detect the collision and/or the collision type.
